(19) United States
(12) Patent Application Publication
(10) Pub. No.: US 2008/0148393 A1
(43) Pub. Date: Jun. 19, 2008

(54) Neural authenticator and method

(76) Inventor: Barry Myron Wendt, Las Vegas, NV (US)

Correspondence Address: Aaron Passman, 9632 Windom Point Avenue, Las Vegas, NV, 89129-7860, US

(21) Appl. No.: 12/001,954

(22) Filed: Dec. 12, 2007

Related U.S. Application Data
(60) Provisional application No. 60/875,149, filed on Dec. 15, 2006.

(51) Int. Cl. G06F 21/00

(52) U.S. Cl. 726/19

(57) ABSTRACT

A user biometric enabled universal smart card or key system and method of use to verify and authenticate the identity of the user via entry of a neural biometric password before enabling activation of a transaction via a smart card or key in a reader for unlocking an access control system or lock. Dynamic pulsed tactile inputs are enrolled and stored in a circuit with CPU memory and subsequently user entered dynamic pulsed tactile inputs are compared with those stored for verifying, authenticating as a biometric security device. The smart card or key is powered the pulsing of the input pressure sensors. CPU software and firmware analyzes neural biometric pulsed inputs of the neural biometric password for thereafter authorizing enablement via the pulsed neural biometric password entered so a signaling circuit responds to authorization for submitting enablement to the smart card or key reader, access control system or key lock.

### CROSS-REFERENCE TO RELATED APPLICATIONS

This application is based on provisional appl. No. 60/875,149 filed Dec. 15, 2006 as User Enabled Universal Smart Card or Key now titled: Neural Authenticator and Method

### STATEMENT REGARDING FEDERALLY SPONSORED RESEARCH

Not Applicable

### SEQUENCE LISTING

Not applicable

### BACKGROUND OF THE INVENTION

This neural authenticator apparatus and method provides a user biometric enabled universal smart card or key system that incorporates an additional layer of biometric based security not found in current smart card or key technologies. It is also compatible with existing contact type smart card or key readers, contact-less smart cards or keys that use RFID, radio frequency identification concept readers and replaces legacy type magstripe cards while maintaining compatibility with legacy magstripe card readers. The authenticator and method replaces existing access control systems, locks and keys with dynamic pulsed tactile inputs based technology and method that measures unique neurological and other physical characteristics of a user.

This user biometric enabled universal smart card or key system has market application as generally outlined herein and has more specific application to the field of use as also herein described. Biometrics authentication is the science and technology of measuring and analyzing human body characteristics such as fingerprints, eye retina and irises, voice and facial patterns and hand geometry for the purpose of validating an individual identity. Generally, the process involves measuring such physical characteristics using various algorithms to produce a biometric template stored for later recall by an authentication system that compares the stored template to a subsequent generated template to determine a probability of match. If the templates match sufficiently for the physical characteristics being measured, the individual's identity is authenticated and an associated transaction, access, permission or other authority is enabled. All biometric authentication systems have their own individual deficiencies and self-imposed barriers to an ideal market implementation. An ideal biometric authentication system should be compatible with existing infrastructure and applications, thus eliminating any requirement to change or make additions to the existing infrastructure. The user biometric enabled universal smart card or key system accomplishes this ideal goal.

Whereas biometric authentication systems based on fingerprints, eye retina and irises, voice and facial patterns and hand geometry, etc. all require the addition of various reader, sensor and interface technologies to interface with existing card based transaction systems and access control systems. These additional readers, sensors and interface technologies add significant cost and complexity to providing for biometric authentication applications.

Many traditional biometric authentication systems also have smart card, proximity or magstripe card technology to store the user's biometric template for comparison to a real-time generated template for user authentication and transaction authorization. The user biometric enabled universal smart card or key system contains sufficient memory to store multiple biometric templates and card specific data associated with multiple card vendors thereby allowing for the convenient consolidation of all a user's cards into one biometrically secure card. This ability to consolidate multiple cards into a single user biometric enabled universal smart card or key system represents an opportunity to provide for a new form of biometric security while actually reducing implementation costs as compared to standard card based solutions while maintaining current infrastructure compatibility.

Another common problem with transaction based systems and access control systems based on various card technologies is that the card can be lost or stolen and subsequently used by someone other than the rightful owner. In addition, various proximity card type cards can be spoofed via inexpensive electronic eavesdropping devices. The user biometric enabled universal smart card or key system solves these problems by only enabling the card for use, for a specified window of time following the biometric authentication process. In addition, if an unauthorized user repeatedly attempts to use the card, it permanently disables itself.

### SUMMARY OF THE INVENTION

The user biometric enabled universal smart card or key, incorporates all the functionality of typical contact smart cards or keys, contact-less RFID based smart cards and legacy type magstripe cards or keys. An extra layer of biometric based security is provided versus existing technologies by using an embedded user activated power source and a user-entered neural biometric password that enables the card or key for use. Once enabled, the card or key can preferably be used with any compatible card or key reader and application for a predetermined operational window of time. Following the operational window, the card or key will automatically be disabled. The preceding provides an additional layer of biometric based security to protect against card or key theft, cloning, counterfeiting or electronic eavesdropping and manipulation.

A user entered neural biometric password that enables timely operation of the user biometric enabled universal smart card or key system operation, and the neural biometric password is totally independent of any other current passwords, pin numbers or systems that secure current card or key-based transactions. The user entered neural biometric password is accomplished via two embedded piezo electric transducers in the card or key and is based on a biometric technology concept that measures unique neurological characteristics of the user. The unique neurological characteristics arises from a user's neural, i.e., thought of, a password phase the user has selected and enrolled to control enabling of the user biometric enabled universal smart card or key. The preceding provides for a very large number of secret possible neural biometric password enabling combinations that may be used only by the user. The user biometric enabled universal smart card or key is permanently disabled after several incorrect neural password entry attempts. The piezo electric transducers also provide power to all embedded electronic components of the user biometric enabled universal smart card or key.

The neural biometric password concept employed by the user biometric enabled universal smart card or key system may be used with, or independent of card or key technologies to replace typical keys, cards, or other access control methods and devices.

For card or key-based applications the user biometric enabled universal smart card or key system resembles and includes typical construction methods and nomenclature found in current smart card or magstripe card technologies. The user biometric enabled universal smart card or key system has embedded piezo electric transducers, circuitry and firmware to provide for powering embedded logic, user neural biometric password entry and storage for use in enabling of the card or key. These additional embedded circuits will generally be transparent to the user other than for two circular areas that will be printed on the face of the card or key above the embedded piezo electric transducers. In addition, in the card or key small transparent areas change into non-transparent areas when the card or key during neural biometric password entry or is in an enabled mode.

For replacement of keys and other access control systems, the user biometric enabled universal smart card or key system may take the form of a card or key as previously described or it may simply take the form of two embedded circular areas that are used for neural biometric password entry to an electronic lock system. Materials such as plastics, Mylar, etc. suitable for embedding the piezo electric transducers and associated circuitry may be used.

An object provides for a new user biometric enabled universal smart card or key system that includes an additional layer of security for neural biometric authentication not found in current smart card or key technologies that is also compatible with existing contact type smart card or key readers, contact-less smart cards that use RFID concept readers and replaces legacy type magstripe cards while maintaining compatibility with legacy magstripe card readers. To replace existing access control systems, locks and keys with a Biometric based technology that measures unique neurological characteristics of a user that represents a significant improvement over prior technology.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. To have therein dynamic pulsed tactile inputs based technology that measures unique neurological characteristics of a user provides for biometric authentication for enabling access replaces with greater security existing access control systems, locks and keys of existing card or key based transaction systems and access control systems without requiring any infrastructure change to such existing systems.

Another object provides for a user biometric enabled universal smart card or key system that includes a neural biometric layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. Dynamic pulsed tactile inputs based technology measures, records and compares unique neurological characteristics of a user to provide additional protection to the user from theft, electronic tampering, electronic eavesdropping and counterfeiting of their card by disabling the card when used by anyone else. The user's unique dynamic pulsed tactile inputs are based on neural biometric password entry to enable the card or key for use with existing access control systems, locks and keys.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. The improvement upgrades typical non-biometric access control systems to a biometric controlled access system with the addition of technology an in the card or key. Embeddable dynamic pulsed tactile inputs sensors receive dynamic pulsed tactile inputs that measures and compares the user's stored unique neurological characteristics to secure existing access control systems, locks and keys.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. Dynamic pulsed tactile inputs based technology that measures unique neurological characteristics of a user for authentication and enablement with speaker dependant biometric recognition based on the dynamic pulsed tactile inputs algorithm. The relative easy inclusion in existing access control systems, locks and keys is another benefit.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. A standalone smart card or key powered by piezo electric transducers elegantly replace existing access control systems, locks and keys with dynamic pulsed tactile inputs based technology that measures unique neurological characteristics of the user and compares them with a stored neural biometric password previously entered.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. The user's dynamic pulsed tactile input is received by technology that measures and compares the unique neurological characteristics of a user. That technology provides smart cards or keys that uses piezo electric transducers for user neural biometric password input to secure existing access control systems, locks and keys.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. Voltage sensitive film that changes color to provide for operational smart card or key status displays to the user upon dynamic pulsed tactile input to measures user's neurological characteristics. That technology replaces existing access control systems, locks and keys.

Another object provides for a user biometric enabled universal smart card or key system that includes an additional layer of biometric based authenticating security not found in current smart card or key technologies. The authenticating security is easily added to existing contact type smart card and their readers and that includes contact-less smart cards that use RFID concept readers and replaces legacy type magstripe cards while maintaining compatibility with legacy magstripe card readers. It is therefore compatible with legacy magstripe card readers is provided by using embedded inductors and control logic to emulate a magstripe card. Thus existing access control systems, locks and keys are improved with dynamic pulsed tactile input based technology that measures unique neurological characteristics of a user and compares that with stored a user's neural biometric password.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. Use of appropriate protocol and embedded circuitry to support the sensed card or key reader and associated application allows replacement of existing access control systems, locks and keys with dynamic pulsed tactile input based technology that measures unique neurological characteristics of a user that provides for automatic sensing of card or key reader for authentication.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. Existing access control systems, locks and keys work are accessed dynamic pulsed tactile inputs based technology that measures unique neurological characteristics of a user. That access authenticates a smart card or key that via embedded software that executes the dynamic pulsed tactile inputs algorithm and associated control logic that disables the smart card or key permanently after several incorrect attempts to enter the correct dynamic pulsed tactile inputs neural biometric password phrase.

Another object provides for a user biometric enabled universal smart card or key system that includes an additional layer of biometric based security not found in current smart card or key technologies that is also compatible with existing contact type smart card readers, contact-less smart cards that use RFID concept readers and replaces legacy type magstripe cards while maintaining compatibility with legacy magstripe card readers. Improving existing access control systems, locks and keys for receiving dynamic pulsed tactile inputs via technology that measures unique neurological characteristics of a user and replaces several cards or keys including contact and contact less type cards and magstripe type cards thereby resulting in an authenticating one user biometric enabled universal smart card or key system.

### BRIEF DESCRIPTION OF THE DRAWINGS

FIG. 1 is a top plan view of the user biometric enabled universal smart card or key.

FIG. 2 illustrates graph or the waveform or plot of the amplitude against time of an entered neural password phrase submitted via dynamic pulsed tactile inputs.

FIG. 3 is a block diagram of the circuitry of the user biometric enabled universal smart card or key system of FIG. 1.

FIG. 4 is a block diagram of the steps of the method of use of the user biometric enabled universal smart card or key system of FIG. 1 for transaction authorization to a card or key reader or unlocking of an electronic lock or access control system.

### DETAILED DESCRIPTION

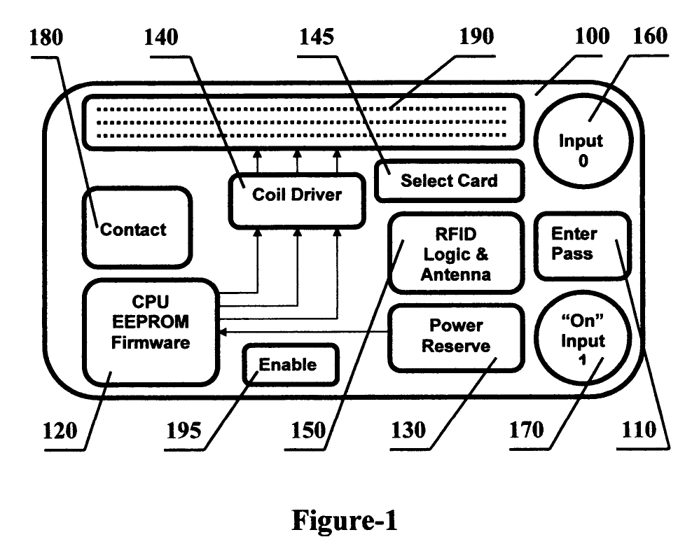

The following drawings further illustrate advantages and objects of a user biometric enabled universal smart card or key system 100 within a dynamic pulsed tactile inputs authenticator apparatus and method. The attached FIG. 1 through FIG. 4 illustrates the sub operation of user biometric enabled universal smart card or key system 100 and what is therein included. According to the present preferred embodiment user biometric enabled universal smart card or key system 100 has an additional layer of biometric security not found in current smart card or key technologies and it is also compatible with existing contact type smart card or key readers, contact-less smart cards that use RFID concept readers and replaces legacy type magstripe cards while maintaining compatibility with legacy magstripe card readers. It also can replace existing access control systems, and keys with a biometric based technology that measures unique neurological characteristics of a user.

For card or key-based applications the user biometric enabled universal smart card or key system 100 resembles typical construction methods, materials and nomenclature found in current smart card or magstripe card technologies but adds authentication security. User biometric enabled universal smart card or key system 100 also includes embedded piezo electric transducers 160 and 170, circuitry and CPU EEPROM firmware 120 to provide for powering embedded logic, user neural biometric password entry and enabling of the card. These embedded piezo electric transducers 160 and 170 and all other circuitry will generally be unseen or transparent to the user other than for two circular areas juxtaposed over piezo electric transducers 160 and 170 in FIG. 1. The circular areas may be printed on surface of the face of the card or key above the embedded piezo electric transducers 160 and 170. In addition, unseen or transparent areas are incorporated in the cards or keys that change into opaque or non-transparent colored areas when the card or key is during neural biometric password entry or in an enabled mode.

For replacement of keys and other access control systems, user biometric enabled universal smart card or key system 100 is preferred to be in the form of a card or key as previously described or it may simply take the form of two embedded circular areas which are used for neural biometric password entry to any electronic lock or security opened or operated by key or card. In the case of a non-card or key application, user biometric enabled universal smart card or key system 100 could be mounted conveniently as a small panel on a wall by a door, on the dash of a car, on the surface(s) of a door handle, etc. Materials such as plastics, Mylar, etc are suitable for embedding the piezo electric transducers 160 and 170 and associated circuitry. User biometric enabled universal smart card or key system 100 has market applications as replacements for existing security schemes are preferably and specifically implemented as herein after explained.

FIG. 1 illustrates a top plan view of user biometric enabled universal smart card or key system 100 with the surface removed to show wherein the operative components may be positioned. User biometric enabled universal smart card or key system 100 as a replacement for existing smart cards or keys or magstripe cards is constructed using standard smart card or key materials, methods and described with the nomenclature of typical smart cards or keys currently in use today.

User biometric enabled universal smart card or key system 100 incorporates the embedded smart card or key CPU 120 which includes therein appropriate firmware code and EEPROM for implementing smart card or key functions in addition to inclusion of biometric based neural biometric password input using specifically referenced embedded piezo transducer 160 and 170, sensor INPUT0 at 160 and sensor INPUT1 at 170, respectively.

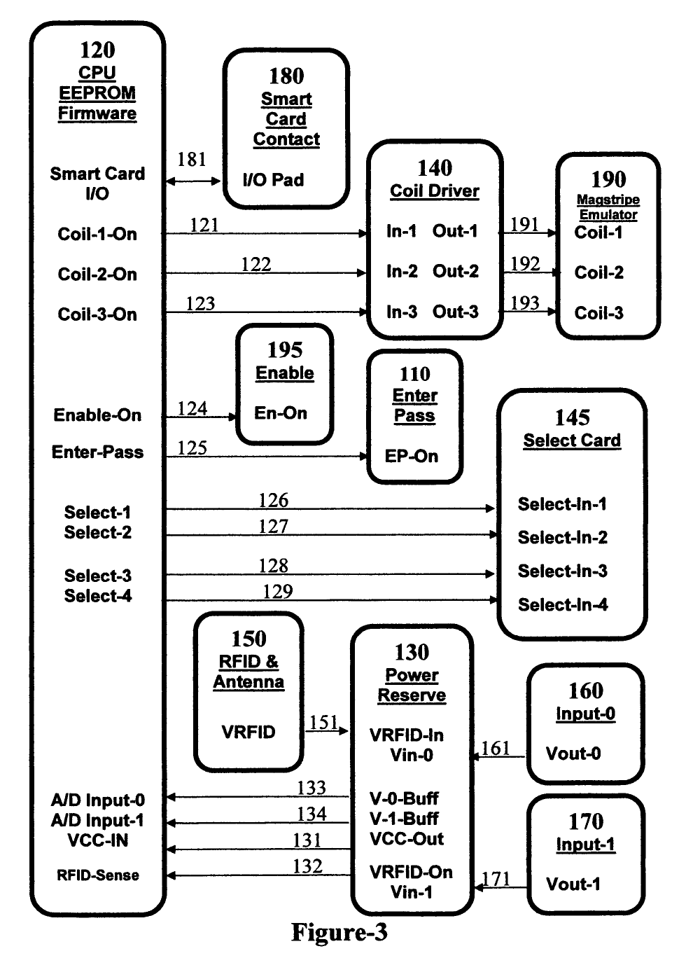

Referring also to FIG. 3 which illustrates a block diagram of the embedded circuitry, power reserve 130 in circuit with the herein after described electronic components provides power to all embedded circuitry of user biometric enabled universal smart card or key system 100 and is charged by the user squeezing or applying pressure to piezo electric transducers 160 and 170 at INPUT0 or at INPUT1. In addition, power reserve 130 can receive charging current from RFID logic and antenna 150 via a connection 151. Power reserve 130 can consist of typical storage cells or other capacitive technologies alternately or as additionally employed in current smart card or key technologies for energy storage and provision. Referring specifically to FIG. 3, power reserve 130 consists of a power rectifying circuit which receives charging current from the Vout-0 through connection 161, Vout-1 coupled by 171 outputs of piezo electric transducers 160 and 170 and VRFID 151 from RFID logic and antenna 150, respectively. Power reserve 130 uses these described charging current sources to charge it's own internal power supply reservoir. Power reserve 130 provides all operating power to all embedded circuitry of user biometric enabled universal smart card or key system 100 via VCC-Out 131 in circuit between power reserve 130 and CPU 120.

Referring to FIG. 1, embedded piezo electric transducers 160 and 170 at INPUT0 and at INPUT1 produce an output voltage and current when pressure is applied to them. The resulting energy is used not just to charge power reserve 130, but also to initiate a neural biometric password entry process and to input a neural biometric password for enrollment and/or activation of user biometric enabled universal smart card or key system 100.

RFID logic and antenna 150 is constructed using typical methods employed for current non-contact smart card or key technologies. Energy received by the antenna portion of RFID logic and antenna 150 is also directed to charge power reserve 130. RFID logic and antenna 150 will support, but is not limited to, typical non-contact smart card protocols including ISO 14443 A and B.

Contact 180 in FIG. 1, provides support for smart card or key applications and readers that use contact based readers and will support, but is not limited to, contact smart card or key protocols including ISO 7816. Contact 180 is constructed using typical methods employed for current contact smart card or key technologies. Referring to FIG. 3, Contact 180 communicates with CPU 120 EEPROM firmware using the I/O Pad 180 bus. Power, communication data and smart card reader sensing is accomplished using I/O pad connected via bus 181 to CPU 120.

Referring to FIG. 1 and FIG. 3, magstripe simulator 190 includes embedded coils that are constructed using flex circuitry or may consist of thin passive inductors. When user biometric enabled universal smart card or key system 100 is used in a standard magstripe reader such as HiCo Magstripe or LoCo Magstripe readers, a coil driver 140 drives current pulses through magstripe simulator 190 via the Coil-1 through connection 191, Coil-2 through connection 192 and Coil-3 through connection 193 as inputs to produce a data stream that is picked up by the magstripe reader as though a standard magstripe card had been used. Magstripe simulator 190 and embedded firmware of smart card or key CPU EEPROM 120 which uses the Coil-1-On through connection 121, Coil-2-On through connection 122 and Coil-3-On through connection 123 as outputs to implement all standard magstripe card formats including ANSI, ISO and ABA. The disclosed concept of magstripe simulator 190 as described in this disclosure also would accommodate any custom or future magstripe encoding format including additional tracks not currently defined as belonging to an existing magstripe protocol.

Smart card or key CPU 120 with EEPROM contains firmware code, integrated sensors and interface logic to automatically detect whether the user biometric enabled universal smart card or key system 100 is being used in a contact, non-contact or magstripe reader application and as such, the appropriate protocol is executed as required automatically with the appropriate embedded circuitry of user biometric enabled universal smart card or key system 100.

Referring to FIG. 3, detection of the type of card reader being used for a given card transaction is determined by embedded firmware code of CPU 120 EEPROM by sensing the I/O Pad through connection bus 181 to determine if a smart card reader is being used, if not, VRFID-On through connection 132 is checked to determine if a proximity reader is being used, if not, the default of a magstripe card reader is used.

Referring to FIG. 1, enable indicator 195 includes a transparent area that is clear when the user biometric enabled universal smart card or key system 100 is disabled and turns green, opaque or another color when the user biometric enabled universal smart card or key system 100 is activated by correct input of a user neural biometric password via embedded piezo transducers sensors 160 and 170 at INPUT0 and at INPUT1, respectively. Enable indicator 195 includes an embedded laminated film that changes color to show when an internal voltage is applied to it after successful entry of the user neural biometric password. Referring to FIG. 3, En-On through connection 124 input of enable indicator 195 causes the transparent area of enable indicator 195 to change color as directed by an output of CPU 120 EEPROM.

Referring to FIG. 1, enter pass 110 includes a transparent area which is clear when user biometric enabled universal smart card or key system 100 is disabled but turns yellow, opaque or any other color when user biometric enabled universal smart card or key system 100 is ready or active to receive a user entered neural biometric password using embedded piezo transducers sensors 160 and 170 at INPUT0 and at INPUT1. Enter pass 110 includes an embedded laminated film that changes color when an internal voltage is applied to it following pressure being applied at INPUT1 of embedded piezo transducer sensor 170 several times to power up user biometric enabled universal smart card or key system 100. In this manner, INPUT1 of embedded piezo transducer sensor 170 also acts as a temporary “ON” key that initiates a user neural biometric password entry process required to power up user biometric enabled universal smart card or key system 100 for use. Referring to FIG. 3, the EP-On through connection 125 supplies input to enter pass 110 and controls the color of enter pass 110 as determined by an output of CPU 120 EEPROM.

User biometric enabled universal smart card or key system 100 is intended as a replacement for existing card or key technologies while at the same time maintaining compatibility with existing standards and card or key reader technologies. Using the appropriate reader, existing smart cards or keys and magstripe cards can have their encoded data read and downloaded to user biometric enabled universal smart card or key system 100. This concept provides for a convenient and secure method for consolidation of multiple cards or keys into one user biometric enabled universal smart card or key system 100 that provides for biometric secured transactions for all user card or key transactions regardless of application. Current smart card technologies include sufficient memory to hold data from up to 32 magstripe cards in addition to 16 smart cards or keys.

Select card or key 145 in FIG. 1, consists of a transparent area which is clear when user biometric enabled universal smart card or key system 100 is disabled. Select card or key 145 displays up to 16 different color bar patterns based on a specific user card or key selection using embedded piezo transducers sensors 160 and 170 at INPUT0 and at INPUT1, respectively. As in but one example, a Master Card or key, selection may display a color bar of Red, Orange, Blue and Yellow. Referring to FIG. 3, the color bars are generated using embedded voltage sensitive materials whose output colors are controlled by embedded firmware of CPU 120 EEPROM using Select-1 through connection 126, Select-2 through connection 127, Select-3 through connection 128 and Select-4 through connection 129 outputs of CPU 20 EEPROM to create a color bar on select card or key 145 that indicates a specific user selected card or key has been selected.

Referring to FIG. 1, as an option, the face of user biometric enabled universal smart card or key system 100 can be printed with a color bar chart and graphics to help user's properly select the desired card or key that the user biometric enabled universal smart card or key system 100 is to represent for the current transaction. The graphics would most likely consist of small icon representations of various cards like Master Card, American Express, Discover, etc. The preceding concepts allow a user to consolidate and biometrically secure multiple cards or keys into one user biometric enabled universal smart card or key system 100 for all card or key based transactions regardless of application and to select which card or key they are using for a specific transaction or application.

In a typical operation, user biometric enabled universal smart card or key system 100 is normally disabled to protect against security concerns such as theft, eavesdropping, tampering or electronic hacking attempts. The user would begin activation of user biometric enabled universal smart card or key system 100 by pressing on embedded piezo transducer sensor 170 at INPUT1 a few times to charge up power reserve 130 and in turn provide power to all embedded circuitry of user biometric enabled universal smart card or key system 100. The user will then have a window of time to enter a neural biometric password that begins when enter pass 110 changes from transparent to a color. User's neural biometric password is entered when the user presses embedded piezo transducers sensors 160 and 170 at INPUT0 and at INPUT1, respectively. The manner and timing of the pressing must be consistent with entering the user's unique neural biometric password. This is typically accomplished by holding the circular portions of user biometric enabled universal smart card or key system 100 between the thumbs and index fingers of both hands and squeezing in a rhythm and duration consistent with a pre-enrolled biometric template. Referring to FIG. 3, CPU 120 EEPROM senses the user's neural biometric password entry by monitoring A/D inputs of CPU 120 EEPROM which are fed by V-0-Buff through connection 133 and V-1-Buff through connection 134 of power reserve 130. V-0-Buff through connection 133 and V-1-Buff through connection 134 are logic buffered representations of the Vout-0 through connection 161 and Vout-1 through connection 171 as the outputs of piezo transducers sensors 160 and 170, respectively.

Referring to FIG. 1, on successful neural biometric password entry, user biometric enabled universal smart card or key system 100 will become enabled which will be indicated by enable indicator 195 changing from transparent to a color. Following activation as indicated by enable indicator 195, another time window is started in which the transaction associated with use of user biometric enabled universal smart card or key system 100 must be completed. Following a timeout of the activation window, user biometric enabled universal smart card or key system 100 will disable itself. Repeated failure attempts to enter a correct neural biometric password will result in user biometric enabled universal smart card or key system 100 becoming permanently disabled. After enabling user biometric enabled universal smart card or key system 100 the user may also select a specific card or key they want user biometric enabled universal smart card or key system 100 to represent for the transaction. This is accomplished by squeezing embedded piezo transducer sensor 160 at INPUT0 a number of times to scroll to the desired card or key selection, then the user can squeeze embedded piezo transducer sensor 170 at INPUT1 once to lock in the desired selection.

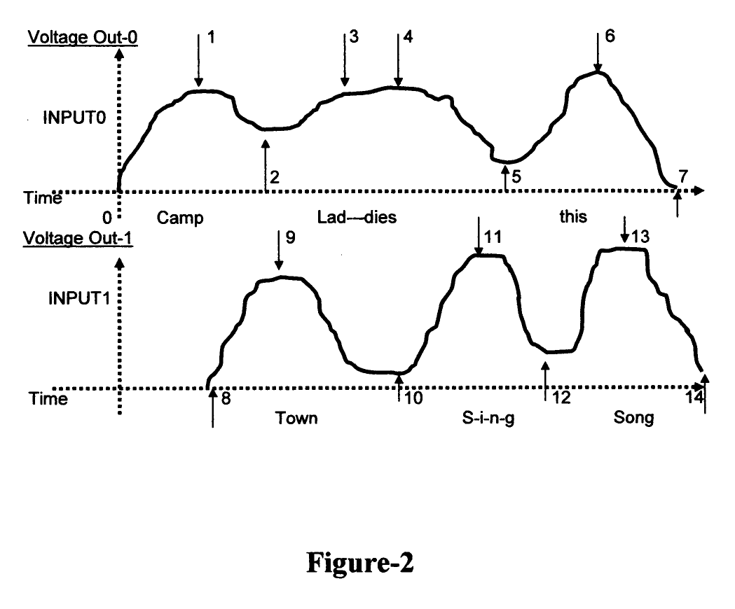

Referring to FIG. 1 and FIG. 2, embedded piezo transducers sensors 160 and 170 at INPUT0 and at INPUT1, respectively are used to deliver unique dynamic pulsed tactile inputs based user neural biometric password and provide charging of power reserve 130 during neural biometric password entry. The example depicted in FIG. 2 displays voltage output versus time of piezo electric transducers sensors 160 and 170 at INPUT0 and at INPUT1, respectively during user neural biometric password entry, which in the example depicted graphically in FIG. 2 is result of index finger pulsations to the users thoughts of, “Camp Town Ladies Sing This Song.”

The dynamic pulsed tactile inputs concept detailed in this disclosure is based on unique neurological properties, physical properties and knowledge that only the individual user has. The knowledge components consist of a neural biometric password phase the user has memorized which the user may choose to silently speak, think or sing when entering that into the card or key with index fingers pulsating. Only in this case, the individual user speaks, thinks or sings the phrase using pulsing input via pressure sensitive piezo electric transducers sensors 160 and 170 at INPUT0 and at INPUT1, respectively. The unique neurological component of the dynamic pulsed tactile inputs concept consists of the timing associated with how an individual user thinks and silently delivers a neural biometric password phrase, whether they think to speak it or sing it and the physical timing and finger pressures applied through pressure sensitive piezo electric transducers sensors at 160 and 170 at INPUT0 and at INPUT1, respectively. This happens during enrollment and subsequently during activation for entry of the neural biometric password phrase. Even if a large number of users implemented the same neural biometric password, there would be significant variations between user neural biometric password inputs such that the probability of one user emulating another user's input is statistically small. In this manner, the dynamic pulsed tactile inputs concept provides for a very large number of possible biometric keys with a simple and fun user interface at low cost.

Referring to FIG. 2, the diagram depicts the output voltage amplitude of pressure sensitive piezo electric transducers sensors 160 and 170 at INPUT0 and at INPUT1, respectively versus time during entry of a user's neural biometric password that in this example is, “Camp Town Ladies Sing This Song.” As input of a neural biometric password could be understood, explained, described, taught or compared to playing two drums, using one hand for each drum and tapping out a rhythm consistent with how an individual's consciousness mentally thinks or sings the neural biometric password phrase. One might start with the left hand or the right hand and different individuals would tap out the same neural biometric password in totally different ways with different timing and volume emphasis or accents.

There are, in the graph of FIG. 2, several points of reference for voltage out “0” for pressure sensitive piezo electric transducer sensor 160 at INPUT0 identified as time references points (horizontal axis) 0 to 7. Likewise there are several reference points of voltage out “1” for pressure sensitive piezo electric transducer sensor 170 at INPUT1 identified as time references points (horizontal axis) 8 to 14 also in FIG. 2. Referring specifically to FIG. 2, reference points 1, 3, 4 and 6 of voltage out “0” represent peak amplitude(s) and time reference marks for INPUT0 relative to the start of neural biometric password entry. Likewise, reference points 0, 2, 5 and 7 represent low amplitude(s) and time reference points for INPUT0. In a similar fashion, reference points 9, 11 and 13 of voltage out “1” represent peak amplitude(s) and time reference marks for INPUT1. Likewise, reference points 8, 10, 12 and 14 represent low amplitude points with associated time marks for INPUT1.

As part of enrollment of the individual's neural biometric password, a dynamic pulsed tactile inputs template (from analysis of the plot of FIG. 2) is constructed using these high and low amplitude points along with associated time marks by initially creating two intermediate templates, INPUT0 template and INPUT1 template. Those intermediate templates are then combined using relative reference timing marks between the INPUT0 and INPUT1 templates to build a unique dynamic pulsed tactile inputs template which is a summary representation of the user's neural biometric password enrolled via the user biometric enabled universal smart card or key system 100.

Specifically, intermediate template “0” based on INPUT0, is constructed using the slope from time mark reference point non to reference point “1” which is a function of the amplitude change and amplitude direction between these two reference points. In a similar fashion additional slope values for intermediate template “0” are constructed from successive time marks, 1 to 2, 2 to 3, 3 to 4, 4 to 5, 5 to 6 and 6 to 7. With each calculated slope value, a time duration is also calculated which is associated with that slope value. This process produces a simple representation of a complex analog signal represented as sequential slope values with associated time durations. The slope values are normalized for variances in piezo electric transducer sensor 160 and 170 sensitivity based on stored historical data associated with piezo electric transducer sensor 160 and 170 sensitivity.

Intermediate template “1” is constructed using the same algorithm used to construct intermediate template “0” except intermediate template “1” is based on amplitude values and associated time marks from INPUT1. In addition, since INPUT1 trails INPUT0, a time duration representative of this delay is added to the front of intermediate template “1”. The final dynamic pulsed tactile inputs template is constructed using the relative timing mark differences between each successive slope pair of the intermediate templates in sequential order that represents the neural biometric password entry process from start to conclusion.

The disclosed concept allows for variations in user neural biometric password entry by building a composite template based on multiple neural biometric password entries during the neural biometric password enrollment process. During this enrollment process, filter rules and allowable variances are also calculated for inclusion into the dynamic pulsed tactile inputs template.

The user biometric enabled universal smart card or key system 100, in it's pre-enrollment state contains an embedded secret pin number which must be entered by the user successfully a number of times before the user biometric enabled universal smart card or key system 100 will activate itself for enrollment of the users neural biometric password phase. This process helps validate that the current user is the correct individual for the current enrollment process and also helps pre-characterize the users input dynamics via the piezo electric transducer sensors prior to enrollment. Using methods previously described in this disclosure the user powers up the card and enters the secret pin number via the piezo electric transducers 160 and 170. They will be instructed to enter the secret pin number via supplied documentation or via a supervised process in a specific manner where each digit of the pin number is entered via piezo electric transducer 160 or 170 at Input0 or Input1 in the following manner; Assuming the secret pin number is “123456”, the instructions may read, “Input0-1, pause, Input0-2, pause, Input1-3, pause, Input0-4, pause, Input1-5, pause, Input1-6, long pause.” The preceding example means, “pulse Input0-1 time then pause, followed by pulsing Input0-2 times then pause, followed by pulsing Input1-3 times then pause, followed by pulsing Input0-4 times then pause, followed by pulsing Input1-5 times then pause, followed by pulsing Input1-6 times than pausing for 5 or more seconds (a long pause).” It should be noted that pulsing Input0 or Input1 is accomplished as previously described in this disclosure and that the order for entry of the secret pin number could be in any combination of sequence, number of digits and or number of entry processes (i.e., the user could be instructed to repeat entry of a pin number or neural biometric password phrase as part of the systems learning process in building a robust dynamic pulsed tactile inputs template).

Following the secret pin number verification process, the user biometric enabled universal smart card or key system 100 initiates the neural biometric password enrollment phase which is indicated by select card or key 145 flashing every few seconds coincident with enter pass 110 changing from transparent to another color which indicates the user should begin entry of their unique neural biometric password phrase using methods previously described in this disclosure. Prior to such enrollment, the user would typically complete a form which details each word or syllable and the sequence of entry for their password phrase. As an example, a user might select “Input0-Mar, Input1-y, Input1-had, Input0-a, Input0-little, Input0-lamb. Which is simply “Mary Had a Little Lamb”, that is pulsed in on the selected sensors as defined using the timing and pressure associated with the user's thought process and other physical characteristics. Following entry of the users biometric password phrase, the user should pause for a least 5 seconds to indicate they have completed password phase entry. At this time the user biometric enabled universal smart card or key system 100 will analyze the entered password phase and build a dynamic pulsed tactile inputs template.

The user biometric enabled universal smart card or key system 100 may prompt the user to enter their neural biometric password phase several times as part of training, building and optimizing a reliable and sound dynamic pulsed tactile inputs template. Once the user biometric enabled universal smart card or key system 100 has determined there are no significant statistical variances associated with the neural biometric password phase entry process and the stored dynamic pulsed tactile inputs template, the user is notified that the password phase entry enrollment process is completed by enable 195, enter pass 110 and select card or key 145 simultaneously flashing thereby indicating a successful enrollment of the users neural biometric password phrase. After a pre-defined window of time, this is followed by the user biometric enabled universal smart card or key system 100 powering down.

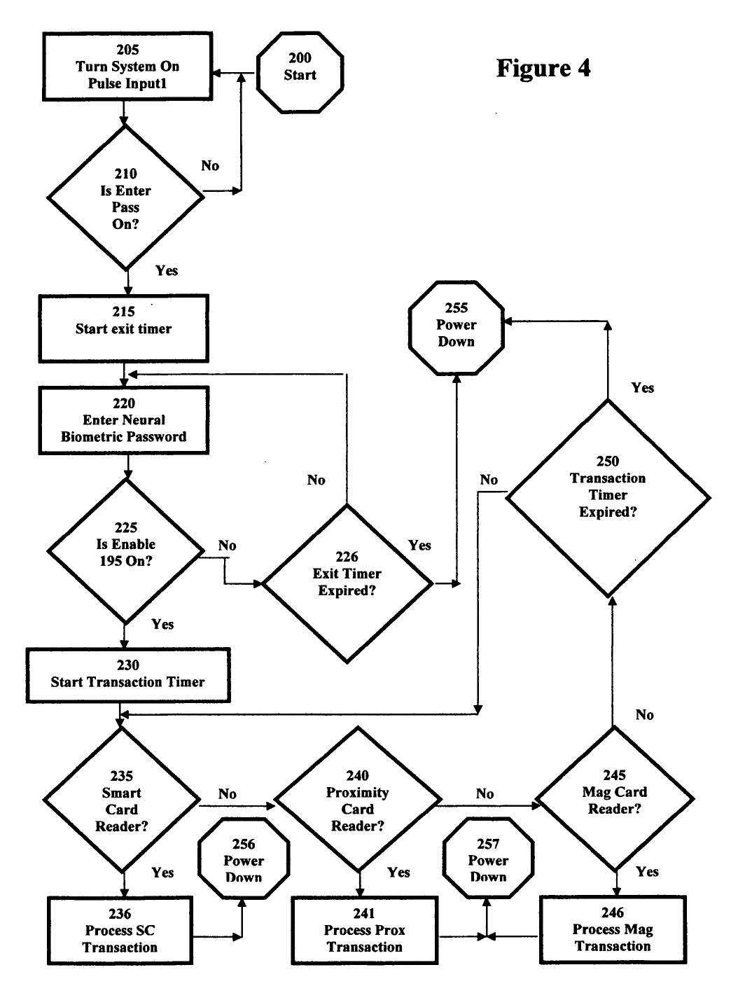

In FIG. 4 there is shown a block diagram of the steps of a typical method of use of user biometric enabled universal smart card or key system 100 of FIG. 1 for authorization of a transaction delivered to a card or key reader or unlocking of an electronic lock or access control system. User biometric enabled universal smart card or key system 100 is powered up in step 205 by applying pressure several times to the Input1 sensor 170. This is followed by step 210 wherein the user waits for the enter pass display 110 to change color while repeating step 205. Once the enter pass is displayed as on, the system starts an exit timer in step 215 which limits how many attempts can be made for password entry over a finite period of time.

User biometric enabled universal smart card or key system 100 then prompts the user to enter their neural biometric password phase in step 220. Following the determination of unsuccessful password entry in step 225 the exit timer is checked and the system powers down in step 255 if the exit timer has expired. If the exit timer has not expired the user is once again prompted to enter their neural biometric password phrase. Determined successful entry of the neural biometric password phrase in step 225 causes a transaction timer to be started in step 230. This is followed by determination of whether the transaction is to be a smart card based transaction in step 235. If it is, control is passed to step 236 and industry standard smart card protocols are executed followed by user biometric enabled universal smart card or key system 100 powering down in step 256. If step 235 determines this is not a smart card transaction, control is passed to step 240 to determine if this is a proximity card transaction. If it is a proximity card transaction, control is passed to step 241 and industry standard proximity card protocols are executed followed by user biometric enabled universal smart card or key system 100 powering down in step 257. If step 240 determines this is not a proximity card transaction, control is passed to step 245 to determine if this is a magstripe card based transaction. If it is a magstripe card transaction, control is passed to step 246 and industry standard magstripe card protocols are executed followed by user biometric enabled universal smart card or key system 100 powering down in step 257. If step 245 determines there is no magstripe card transaction pending control is passed to step 250 where the transaction timer is checked for expiration. If the transaction timer has expired user biometric enabled universal smart card or key system 100 is powered down in step 255, otherwise control is passed back to step 235, 240 and 245 once again testing for a valid transaction pending by determining if a smart card reader, proximity card reader or magstripe card reader has been detected. The user biometric enabled universal smart card or key system 100 has logic and embedded firmware to detect all such reader technologies.

A dynamic pulsed tactile inputs algorithm can be applied to the identification of a number of analog signals including speech or analog sensor inputs. Interestingly and most important to security, while the algorithm produces the template, the template cannot be used to generated the algorithm. It is this one way-ness that helps make this secure. Thus in the case of speech or speaker dependant recognition, the user's voice is run through a set of band pass filters which produce analog signals similar to those depicted in the graph of FIG. 2. The relationship of the multiple signals produced is then used to build a template for subsequent matching and recognition. The process is similar to dynamic pulsed tactile inputs concept only in this case, a voice phrase with frequency characteristics is identified, as speaker dependant voice recognition. In a like but less specific manner, an analog audio signal could be monitored for specific matches to stored templates, or analog sensors can be monitored for specific patterns to trigger another system or generate an alert. Similarly, impersonators may get the voice reproduction for a specific phrase(s) but the secret pattern of dynamic pulsed tactile inputs described herein remains essentially hidden.

This is the first application of dynamic pulsed tactile inputs based on a users neural biometric password to associate electronically an individual to a smart card or key by establishing a curve and matching that to a stored reference via points and/or slopes and/or timing. While a card or key to operate with a reader or lock have been specifically disclosed it is intended that the comparison, verification and authentication by the claimed user biometric enabled universal smart card or key system including any type of interfacing entry device even not contact proximity arrangements. Though not mentioned herein skilled artisans will recognize and appreciate that the neural biometric qualification apparatus and method disclosed and claimed are sought to be protected with any application.

Specifically, variations in the preceding algorithm which incorporate different encoding schemes using identification of various amplitude points, slope values, time duration between reference points and relative relationships between the preceding for multiple analog signals, variations in the physical or operational characteristics of the invention, including methods of construction, material, analog input sensors used, nomenclature, use or application should be considered as evident alternatives to the current invention and as such should fall within the scope of the current invention.

Other applications for which the algorithm matching has usefulness includes a low cost access terminal using a magstripe card reader with a USB interface to conduct biometric secured transactions over networks including the Internet to eliminate e-commerce fraud. Likewise for use as a biometric secured computer access or workstation logon device. And also for use as a biometric secured vehicle access key and ignition enabling system. Or, to sort impaired drivers, that due to alcohol or drugs may fail neural biometric password entry. And, most broadly as a general purpose access control system for any purpose. This could be used for application where scanning complex multi-track analog signals in real time for specific content including speaker dependant voice recognition, specific analog sensor patterns and their associated relationships or audio signals for evidence of piracy copyright crimes such as duplicated films or recordings.

In passport Identification applications homeland security could be increased and likewise for driver license verification systems, to insure that the license has not been falsified. To protect against unauthorized use of any general-purpose card or key during an authorization step in transaction process.

Variations in the physical characteristics of the user biometric enabled universal smart card or key, including methods of construction, material used or nomenclature should be considered as evident alternatives to the current description or implementation of the present user biometric enabled universal smart card or key. Variations in the preceding objects that are apparent from the incorporated descriptions and drawings contained herein are considered to be within the scope of the invention.

Although the user biometric enabled universal smart card or key system herein has been described with reference to particular embodiments, it is to be understood that these embodiments are merely illustrative of the principles and applications of the present user biometric enabled universal smart card or key. It is therefore to be understood that numerous modifications may be made to the illustrative embodiments and that other arrangements may be devised without departing from the spirit and scope of the present user biometric enabled universal smart card or key system as defined by the appended claims.

1. A user biometric enabled universal smart card or key system for use in verifying and authenticating the identity of the user via entry of a neural biometric password before enabling activation of a transaction via a smart card or key reader, proximity card or key reader, magstripe card reader or enabling access by unlocking an access control system or lock with dynamic pulsed tactile inputs, the user biometric enabled universal smart card or key system which comprises:
a circuit with CPU and memory, power generation via input sensors, pressure sensors, comparison, verification, authenticating and signaling software and firmware to analyze neural biometric pulsed inputs as a biometric security device for a smart card or key;
one or more tactile sensitive transducers on the smart card or key for the user to enroll and enter with dynamic pulsed tactile inputs of the neural biometric password,
a neural biometric-password enrollment storage site in the memory,
a comparison, verification and authentication storage site in the CPU for receipt of the entered neural biometric password and analysis thereof for thereafter authorizing enablement via the pulsed neural biometric password entered, compared and verified, and
a signaling circuit responsive to authentication for submitting the authorizing enablement to the smart card or key reader, access control system or key lock.

2. The user biometric enabled universal smart card or key system of claim 1 that incorporates an additional layer of security for neural biometric authorization with biometric based sensors within the CPU an EEPROM measures and compares unique neurological characteristics of a user.

3. The user biometric enabled universal smart card or key system of claim 1 that incorporates an additional layer of biometric based authenticating security with a dynamic pulsed tactile inputs based technology that measures unique neurological characteristics of a user that provides for biometric enabled access to existing card or key based transaction systems and access control systems through the circuit including compatible process that avoids any infrastructure change to existing smart card reader access control systems or key lock systems.

4. The user biometric enabled universal smart card or key system of claim 1 that incorporates a neural biometric layer of authenticating security not found in current smart card technologies that is also compatible with existing contact type smart card or key readers, contact-less smart card or key readers, legacy magstripe card readers which uses dynamic pulsed tactile inputs based technology that measures secret unique neurological characteristics known only to the user wherein the circuit provides additional protection to the user from theft, electronic tampering, electronic eavesdropping and counterfeiting of their card or key by disabling the card or key when not in use by requiring entry of neural biometric password via dynamic pulsed tactile inputs for entry to enable the card or key authentication use.

5. The user biometric enabled universal smart card or key system of claim 1 the circuit incorporates that stores, measures, and compares the users stored neurological characteristics to upgrade of typical non-biometric access authorization control systems to biometric controlled enabled access controlled systems with the addition of one or more in the card or key embeddable dynamic pulsed tactile inputs piezo sensors.

6. The user biometric enabled universal smart card or key system of claim 1 where the circuit includes dynamic pulsed tactile inputs based technology that measures unique neurological characteristics of a user hides speaker dependant biometric recognition with dynamic pulsed tactile inputs as an algorithm camparison, verification and authentication.

7. The user biometric enabled universal smart card or key system of claim 1 the circuit includes dynamic pulsed tactile inputs based technology that measures unique neurological characteristics of a user that provides as a standalone smart card or key powered by piezo electric transducers that also receive the user neural biometric password as dynamic pulsed tactile of the user inputs.

8. The user biometric enabled universal smart card or key system of claim 6 the circuit includes dynamic pulsed tactile inputs based technology that measures unique neurological characteristics of a user that provides for a smart card or key that uses piezo electric transducers for user neural biometric password entry for comparison in the memory with a stored user neural biometric password template indicative of enrolled dynamic pulsed tactile inputs.

9. The user biometric enabled universal smart card or key system of claim 1 that includes voltage sensitive film over the one or more tactile sensitive transducers that change color to provide for operational smart card or key status displays to the user.

10. The user biometric enabled universal smart card or key system of claim 8 that includes embedded inductors and control logic to emulate a magstripe card.

11. The user biometric enabled universal smart card or key system of claim 1 that includes in the memory appropriate protocol and the circuit has embedded circuitry to support the sensed card or key reader and associated application for enablement.

12. The user biometric enabled universal smart card or key system of claim 8 that incorporates in the circuitry embedded software that executes the dynamic pulsed tactile inputs as the algorithm and associated control logic for disabling the smart card or key permanently after several incorrect attempts to enter the correct dynamic pulsed tactile inputs secret hidden neural biometric password.

13. The user biometric enabled universal smart card or key system of claim 1 that incorporates in the circuit an additional layer of biometric based authenticating security not found in current smart card or key technologies that circuit is also compatible with existing contact type smart card or key readers, contact less smart cards or keys that use RFID concept readers and replaces legacy type magstripe cards while maintaining compatibility with legacy magstripe card readers to replace existing access control systems, locks and keys with a dynamic pulsed tactile inputs for measuring neurological characteristics of a user that permitting replacement of several smart cards or keys consisting including contact and contact-less type cards or keys and magstripe type cards thereby resulting in one user neural biometric password enabled smart card or key system.

14. A method of the use of a user biometric enabled universal smart card or key system for use in verifying and authenticating the identity of the user via entry of a neural biometric password before enabling activation of a transaction via a smart card or key reader, proximity card or key reader, magstripe card reader or enabling access by unlocking an access control system or key lock with dynamic pulsed tactile inputs, the user biometric enabled smart card or key system verifying the identity of the user via entry of a neural biometric password before activation of a smart card reader or key lock with the steps of:
providing a circuit with CPU including memory, power generation via input pressure sensors, comparison, verification, authenticating and signaling software and firmware to analyze neural biometric pulsed inputs as a biometric security device for a smart card or key;
enrolling and entering the neural biometric password via dynamic pulsed input pressure sensors via including one or more tactile sensitive transducers on the smart card or key,
storing the neural biometric password enrollment as an algorithm in the circuit with CPU memory for use in the user biometric enabled universal smart card or key system,
analyzing and verifying within the circuit with CPU by comparison, verification and authentication of the neural biometric password in the memory for thereafter authorizing enablement of the dynamic pulsed tactile inputs of the neural biometric password entered, and
submitting the authenticated and authorized the neural biometric password through a signaling circuit to a smart card or key reader.

15. The method of the use of a user biometric enabled universal smart card or key system of claim 14 with the steps of measuring and comparing unique neurological characteristics of a user that includes an additional layer of authenticating security for neural biometric authorization with biometric sensors and CPU EEPROM.

16. The method of with the steps of claim 14 with the steps of not requiring any infrastructure change to existing card or key based transaction systems and access control systems by using the user biometric enabled universal smart card or key system that incorporates an additional layer of biometric based security with a dynamic pulsed tactile inputs based technology for measuring comparison of user neurological characteristics for biometric enabled access.

17. The method of the use of a user biometric enabled universal smart card or key system of claim 14 with the steps of measuring secret unique neurological characteristics known only to the user and also providing additional protection to the user from theft, electronic tampering, electronic eavesdropping and counterfeiting of their card or key by disabling the card or key when not in use and by requiring entry of dynamic pulsed tactile inputs based neural biometric password entry for enabling the card or key via a neural biometric password but is compatible with existing contact type smart card or key readers, contact-less smart card or key readers and legacy magstripe card readers.

18. The method of the use of a user biometric enabled universal smart card or key system of claim 14 with the steps of enrolling, storing, measuring, and comparing the users enrolled neurological characteristics as an upgrade of typical non-biometric access authorization control systems to biometric controlled enabled access controlled systems by receiving inputs from one or more embeddable dynamic pulsed tactile inputs sensors in the card or key.

19. The method of the use of a user biometric enabled universal smart card or key system of claim 14 with the step of dynamic pulsing of tactile inputs into the user biometric enabled universal smart card or key system for subsequently measuring and comparing unique neurological characteristics of a user by biometric recognition of timely presented dynamic pulsed tactile inputs of the algorithm.

20. The method of the use of a user biometric enabled universal smart card or key system of claim 14 that incorporates with a dynamic pulsed tactile inputs based technology that measures unique neurological characteristics of a user that provides as a standalone smart card or key powered by piezo electric transducers in the input pressure sensors that also receive the user neural biometric password as pulsed inputs.

21. The method of the use of a user biometric enabled universal smart card or key system of claim 14 with the steps of measuring and comparing stored neurological characteristics of a user with a dynamic pulsed tactile inputs via piezo electric transducers in the smart card or key for receiving and delivering the user neural biometric password entry and subsequently for comparing with the neural biometric password stored as user neural biometric password template in the CPU memory.

22. The method of the use of a user biometric enabled universal smart card or key system of claim 14 with the steps of displaying with voltage sensitive film changing color for providing smart card or key status displays to the user.

23. The method of the use of a user biometric enabled universal smart card or key system of claim 21 with the steps of emulating a magstripe card with embedded inductors in the smart card or key and control logic in the CPU.

24. The method of the use of a user biometric enabled universal smart card or key system of claim 14 with the steps of including protocol in the CPU, and embedded circuitry in the smart card or key to support the sensed card or key reader and associated application for enablement.

25. The method of the use of a user biometric enabled universal smart card or key system of claim 14 with the steps of incorporating embedded software in the CPU that executes the algorithm for dynamic pulsed tactile inputs and associated control logic in the CPU that disables the smart card or key permanently after several incorrect attempts to enter the algorithm for dynamic pulsed tactile inputs hidden as neural biometric password.

26. The method of the use of the user biometric enabled universal smart card or key system of claim 14 with the steps of including an additional layer of biometric based security not found in t smart card or key technologies, that is compatible with existing contact type smart card or key readers, contact-less smart cards or keys that use RFID concept readers and replaces legacy type magstripe cards while maintaining compatibility with legacy magstripe card or key readers for and for replacing existing access control systems, locks and keys with dynamic pulsed tactile inputs for measuring and comparing neurological user characteristics as a user biometric enabled universal smart card or key system in place of previous cards or keys.
